(19) United States
(12) Patent Application Publication
(10) Pub. No.: US 2026/0072849 A1
(43) Pub. Date: Mar. 12, 2026

(54) METHOD AND DEVICE FOR FLOATING TAG UTILIZATION IN A COMPRESSED SET-ASSOCIATIVE CACHE

(71) Applicant: Samsung Electronics Co., Ltd., Gyeonggi-do (KR)

(72) Inventors: Brian Connor SCHWEDOCK, San Jose, CA (US); Shashi KUMAR, Fremont, CA (US); Tarun NAKRA, Austin, TX (US)

(21) Appl. No.: 18/971,942

(22) Filed: Dec. 6, 2024

Related U.S. Application Data
(60) Provisional application No. 63/692,412, filed on Sep. 9, 2024.

(51) Int. Cl. G06F 12/12

(52) U.S. Cl. CPC G06F 12/12

(57) ABSTRACT

A method and device are provided in which a controller of a storage device determines whether entries of a tag array and a floating tag array, in a cache memory of the storage device, include an entry that corresponds to an object, in a data array of the cache memory, that is to be fetched or updated. In case that the entries comprise the entry that corresponds to the object, the controller also fetches or updates the object in the data array. The entries comprise tag entries of the tag array and floating tag entries of the floating tag array. The floating tag entries are associated with objects in one or more data entries of the data array, and the objects are smaller than or equal to a data entry size of the data array.

### CROSS-REFERENCE TO RELATED APPLICATION

This application claims the priority benefit under 35 U.S.C. § 119(e) of U.S. Provisional Application No. 63/692,412, filed on Sep. 9, 2024, the disclosure of which is incorporated by reference in its entirety as if fully set forth herein.

### TECHNICAL FIELD

The disclosure generally relates to data compression in a storage device. More particularly, the subject matter disclosed herein relates to reducing cache capacity usage for compressed data in a storage device.

### SUMMARY

In modern computing systems, the cache memory plays a crucial role in bridging the speed gap between a processor and a main memory. Cache memories are designed to store frequently accessed data to reduce the time it takes for the processor to retrieve this data, thereby improving overall system performance.

Data compression is commonly used in memory hierarchies to reduce data bandwidth and cache and/or memory usage. Reducing bandwidth often involves sending fewer requests and/or data blocks. Reducing capacity usage may be more complicated because memory devices may rely on a fixed-size storage granularity.

In a set-associative cache, there is often a one-to-one correspondence between tag-array entries (i.e., tags) and data-array entries (i.e., lines). As a result, a tag entry may only map to one unique physical cache line. Caches typically have a fixed line or data entry size, but compressed objects may have varying sizes. Because each cache line or data entry stores a single compressed object, when the compressed object is smaller than the cache line, the remaining space in the cache line may be wasted.

Sectored caches store smaller objects in subsections of a cache line, and aim to reduce tag storage by reusing tag bits across adjacent cache lines. In a sectored cache, each tag statically maps to multiple fixed subsectors. Compressed caches often use a sectored-like approach to compactly store variable-sized objects with complex tag management to avoid a significant increase in tag space.

One issue with sectored caches is that they do not reduce cache fragmentation. Additionally, compressed caches may be very complex because they handle many different object sizes.

To overcome these issues, systems and methods are described herein for additional floating tags that may correspond to any cache line or data entry. As a result, a single cache line may be associated with multiple tags, and thus, may contain multiple sub-line-sized compressed objects. Multiple compressed objects smaller than a single cache line may share the physical space of the cache line, thereby increasing effective cache capacity.

The above approach increases tag storage to mitigate cache fragmentation, with the mapping between floating tags and cache lines varying dynamically. Additionally, the above approach improves on compressed caches by having a significantly simpler and hardware-friendly design that works well with real system workloads, by using a smaller number of additional tags. The above approach provides no dependence on spatial locality of the cached data to reuse tags across objects.

In an embodiment, a method is provided in which a controller of a storage device determines whether entries of a tag array and a floating tag array, in a cache memory of the storage device, include an entry that corresponds to an object, in a data array of the cache memory, that is to be fetched or updated. In case that the entries comprise the entry that corresponds to the object, the controller also fetches or updates the object in the data array. The entries comprise tag entries of the tag array and floating tag entries of the floating tag array. The floating tag entries are associated with objects in one or more data entries of the data array, and the objects are smaller than or equal to a data entry size of the data array.

In an embodiment, a storage device is provided that includes a cache memory. The cache memory includes a data array having data entries, and a tag array having tag entries corresponding to the data entries of the data array. The cache memory also includes a floating tag array having floating tag entries associated with objects in one or more data entries of the data array. The objects are smaller than or equal to a data entry size of the data array.

In an embodiment, a user equipment (UE) is provided that includes a processor and a non-transitory computer readable storage medium storing instructions. When executed, the instructions cause the processor to determine whether entries of a tag array and a floating tag array, in a cache memory of a storage device, include an entry that corresponds to an object, in a data array of the cache memory, that is to be fetched or updated. In case that the entries include the entry that corresponds to the object, the instructions also cause the processor to fetch or update the object in the data array by the controller. The entries include tag entries of the tag array and floating tag entries of the floating tag array. The floating tag entries are associated with objects in one or more data entries of the data array, and the objects are smaller than or equal to a data entry size of the data array.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating a data storage management system for processing commands in an electronic device, according to an embodiment;

FIG. 2 is a diagram illustrating a set-associative cache with a floating tag array, according to an embodiment;

FIG. 3 is a diagram illustrating object storage in the set-associative cache using floating tags, according to an embodiment;

FIG. 4 is a flowchart illustrating method for performing a look-up operation on a cache with floating tags, according to an embodiment;

FIG. 5 is a flowchart illustrating a method for performing an insertion operation on a cache with floating tags, according to an embodiment;

FIG. 6 is a flowchart illustrating a method for performing a replacement operation on a cache with floating tags, according to an embodiment;

FIG. 7 is a flowchart illustrating a method for performing a replacement operation on a cache with floating tags, according to another embodiment; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

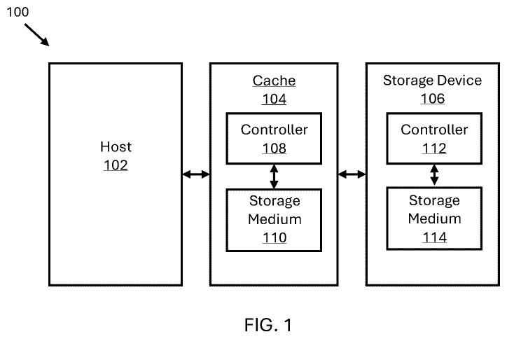

FIG. 1 is a diagram illustrating a data storage management system for processing commands in an electronic device, according to an embodiment. A storage system 100 includes a host 102, a cache memory 104, and a storage device 106 (e.g., a memory device). Although one host and one storage device are depicted, the storage system 100 may include multiple hosts and/or multiple storage devices. The cache memory 104 may include a first controller 108 and a first storage medium 110 in communication with each other. The first controller 108 may be configured to facilitate transfer of data/commands from the host 102 to the first storage medium 110. The storage device 106 may be an SSD, a universal flash storage (UFS), etc. The storage device 106 may include a second controller 112 and a second storage medium 114 in communication with each other. The second controller 112 may be an SSD controller, a UFS controller, etc. The second controller 112 may include one or more processors, one or more error correction circuits, one or more FPGAs, one or more host interfaces, one or more flash bus interfaces, etc., or a combination thereof. The second controller 112 may be configured to facilitate transfer of data/commands from the host 102 to the second storage medium 114. The host 102 may send data/commands to the storage device 106 to be received by the second controller 112 and processed in conjunction with the second storage medium 114. The second storage medium 114 may include a volatile memory, a non-volatile memory, or both, and may include one or more flash memory chips (or other storage media). The cache memory 104 may store data or contents that are used frequently so that they may be easily accessed in a shorter time. Accordingly, a first check for data may be performed at the first storage medium 110 of the cache memory 104. If the data is not found in the cache memory 104, a second check may be performed at the second storage medium 114 of the storage device 106.

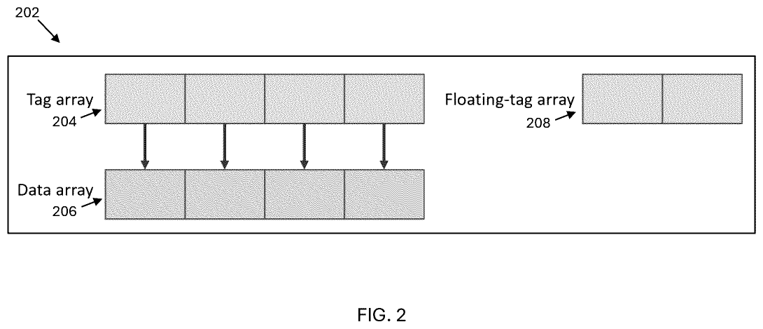

FIG. 2 is a diagram illustrating a set-associative cache with a floating tag array, according to an embodiment. Specifically, FIG. 2 illustrates a layout of a single set of a four-way set-associative cache 202 with two floating tags. The set-associative cache 202 includes a tag array 204 having four entries and a data array 206 having four entries. While four entries are shown for both the tag array 204 and the data array 206, embodiments are not limited to this number and the arrays may contain any number of entries. There is a one-to-one correspondence of entries between the tag array 204 and the data array 206. The set-associative cache 202 also includes a floating tag array 208 having two entries. While two entries are show for the floating tag array 208, embodiments are not limited to this number and the array may contain any number of entries. Each entry of the floating tag array 208 may reference any entry of the data array 206.

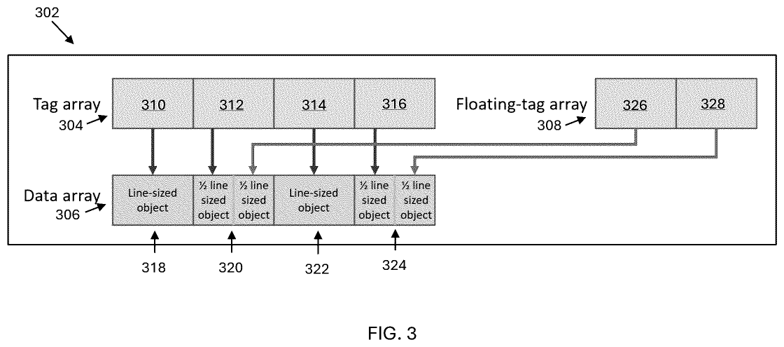

FIG. 3 is a diagram illustrating object storage in the set-associative cache using floating tags, according to an embodiment. Specifically, FIG. 3 illustrates the storage of six objects in a four-way set-associative cache 302 using two floating tags. The set-associative cache 302 includes a tag array 304 having a first tag entry 310, a second tag entry 312, a third tag entry 314, and a fourth tag entry 316. The set-associative cache 302 also includes a data array 306 having a first data entry 318, a second data entry 320, a third data entry 322, and a fourth data entry 324. There is a one-to-on correspondence between entries of the tag array 304 and the data array 306. Specifically, the first tag entry 310 corresponds to the first data entry 318, the second tag entry 312 corresponds to the second data entry 320, the third tag entry 314 corresponds to the third data entry 322, and the fourth tag entry 316 corresponds to the fourth data entry 324. While four entries are shown for both the tag array 304 and the data array 306, embodiments are not limited to this number and the arrays may contain any number of entries.

Each of the tag entries of the tag array 304 may utilize an additional bit to indicate whether its corresponding data entry in the data array 306 is an object having a size of the cache line (e.g., data entry) or an object having half the size of the cache line. For example, the additional bit of the first tag entry 310 and the third tag entry 314 indicates that the first data entry 318 and the third data entry 322 include an object having a size of the cache line. The additional bit of the second tag entry 312 and the fourth tag entry 316 indicates that the second data entry 320 and the fourth data entry 324 include an object having half the size of the cache line. Although two object sizes are shown in FIG. 3, embodiments are not limited to this number and the additional bit with optional metadata may indicate various object sizes.

The set associative cache 302 further includes a floating tag array 308 having a first floating tag entry 326 and a second floating tag entry 328. The first and second floating tag entries 326 and 328 may point to any data entry of the data array 306. As shown in FIG. 3, the first floating tag entry 326 points to the second data entry 320 and the second floating tag entry 328 points to the fourth data entry 324. Each floating tag entry may contain the following fields for the corresponding object: address; coherence state; location pointer to the data array (number of bits=log(data array size)); and optionally, replacement policy state (depending on replacement policy implementation). While two entries are show for the floating tag array 308, embodiments are not limited to this number and the array may contain any number of entries.

Additionally, while FIG. 3 illustrates object sizes of a full cache line or half a cache line, embodiments are not limited to these sizes. The incorporation of additional sizes may require additional metadata (e.g., denoting an offset within a data entry) in the floating tag entries of the floating tag array 308.

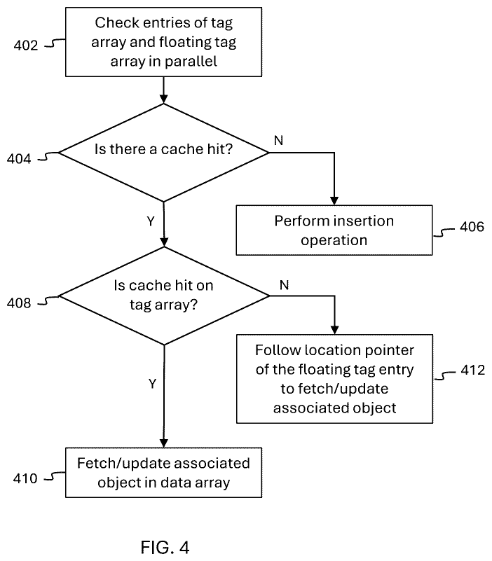

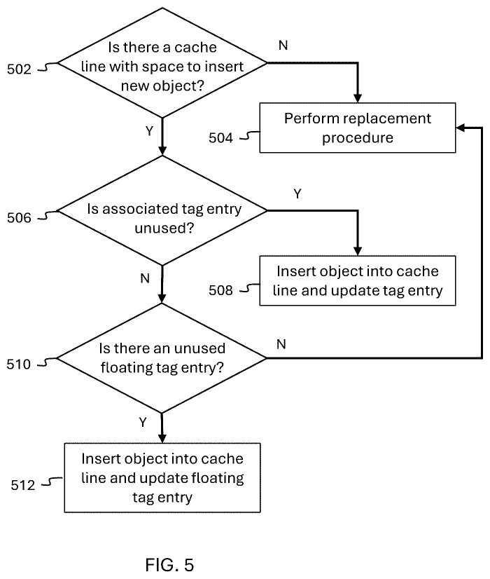

FIG. 4 is a flowchart illustrating a method for performing a look-up operation on a cache with floating tags, according to an embodiment. At 402, tag entries from both a tag array and a floating-tag array may be checked in parallel for an object that is to be fetched or updated. At 404, it may be determined whether the check resulted in a cache hit for the object. If there is not a cache hit, an insertion operation may be performed for the object at 406, as described in greater detail below with respect to FIG. 5. If there is a cache hit, it may be determined whether the cache hit was on the tag array at 408. If the cache hit was on the tag array, an implicitly associated object in the data array (e.g., due to the one-to-one relationship of the entries of the tag array and the data array) may be fetched/updated at 410. If the cache hit was not on the tag array (i.e., the cache hit was on the floating tag array), an explicit location pointer of the hit floating tag entry may be followed to fetch/update an associated object in the data array at 412. Depending on the replacement policy implementation, the associated replacement policy state may be updated.

FIG. 5 is a flowchart illustrating a method for performing an insertion operation on a cache with floating tags, according to an embodiment. As described above with respect to FIG. 4, insertion of an object to the data array may be preceded by a lookup operation that determined that the object is not already cached.

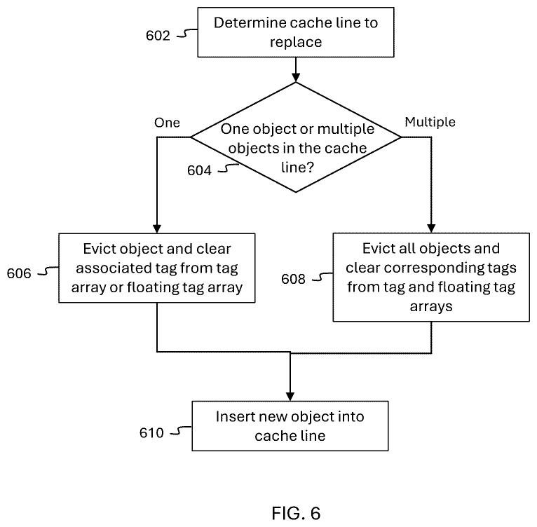

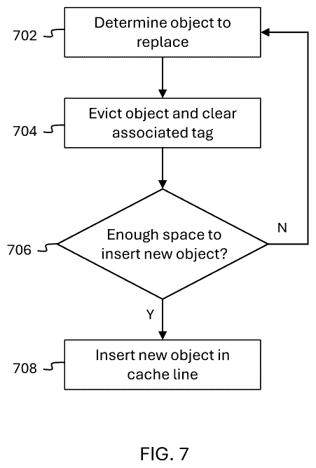

At 502, it may be determined whether there is a cache line (e.g., data entry) in the data array with enough space to insert the new object. If there is not a cache line with enough space to insert the new object, a cache replacement procedure may be performed at 504, as described in greater detail below with respect to FIG. 6 or FIG. 7. If there is a cache line with enough space to the insert the new object, it may be determined whether an associated tag entry of the tag array (e.g., due to the one-to-one relationship of the tag array and the data array) is unused at 506.

If the associated tag entry is unused, the object may be inserted into the cache line of the data array and the associated tag entry of the tag array may be updated to reflect the insertion of the object at 508. If the associated tag entry is used, it may be determined whether there are any unused floating tag entries in the floating tag array at 510. If there is an unused floating tag entry, the object may be inserted into the cache line of the data array and the floating tag entry of the floating tag array may be updated to point to the location of the inserted object in the data array at 512. If there is not an unused floating tag entry (i.e., all floating tag entries of the floating tag array are used), the cache replacement procedure may be performed at 504, as described in greater detail below with respect to FIG. 6.

FIG. 6 is a flowchart illustrating a method for performing a replacement operation on a cache with floating tags, according to an embodiment. A replacement state may be tracked per cache line (in the tag array). The replacement operation may be performed when there is not a cache line in the data array with enough space to fit a new object.

At 602, a cache line (or data entry) that is to be replaced in the data array may be determined by a replacement policy. For example, a replacement state in the tag array may be checked. At 604, it may be determined whether there is one object or there are multiple objects in the cache line that is to be replaced. If there is one object in the cache line, the object may be evicted from the cache line and the associated tag entry may be cleared from the tag array or the floating tag array, at 606. The placement of the associated tag in the tag array or the floating tag array may be derived from the look-up procedure described above with respect to FIG. 4. If there are multiple objects stored in the cache line, all objects may be evicted from the cache line and corresponding tag entries may be cleared from both the tag array and the floating tag array, at 608. For example, one tag entry may be cleared from the tag array and one tag entry may be cleared from the floating tag array. At 610, the new object may be inserted into the cache line.

FIG. 7 is a flowchart illustrating a method for performing a replacement operation on a cache with floating tags, according to another embodiment. A replacement state may be tracked per-object (in the tag array and floating-tag array). At 702, an object that is to be evicted from the data array may be determined based on a replacement policy. At 704, the object may be evicted from the tag array and the associated tag may be cleared in the tag array or the floating tag array. At 706, it may be determined whether there is enough space in the data array to insert the new object. If there is enough space to insert the new object, the new object is inserted in a cache line of the data array in place of the evicted object at 708. If there is not enough space to insert the new object, the methodology may return to 702 to determine another object to be evicted from the data array at 702.

Objects may be repeatedly picked to be replaced by checking the replacement state in both the tag array and floating-tag array, until there is both an available tag (always true after the first replacement) and a cache line with enough space to insert the new object (could require multiple replacements if inserting a full-line-sized object). For each object picked for replacement, it may be evicted and the associated tag may be cleared.

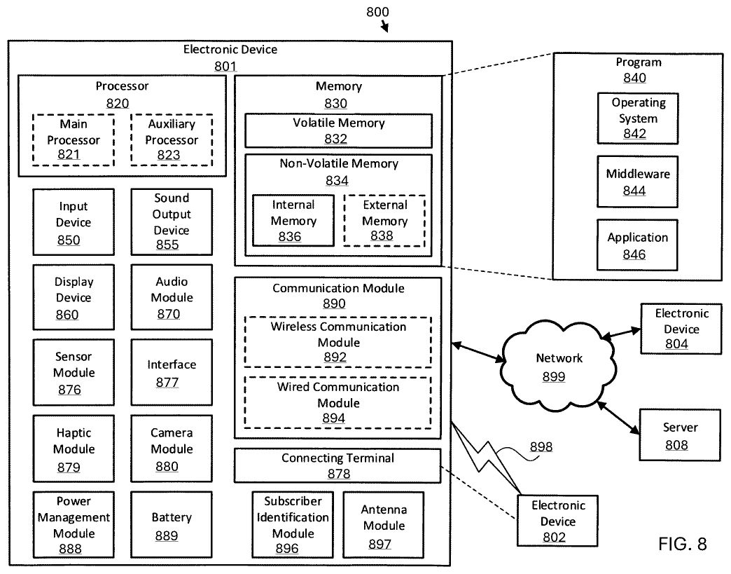

FIG. 8 is a block diagram of an electronic device in a network environment 800, according to an embodiment.

Referring to FIG. 8, an electronic device (or UE) 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
determining, by a controller of a storage device, whether entries of a tag array and a floating tag array, in a cache memory of the storage device, comprise an entry that corresponds to an object, in a data array of the cache memory, that is to be fetched or updated; and
in case that the entries comprise the entry that corresponds to the object, fetching or updating the object in the data array by the controller,
wherein the entries comprise tag entries of the tag array and floating tag entries of the floating tag array, and
wherein the floating tag entries are associated with objects in one or more data entries of the data array, and the objects are smaller than or equal to a data entry size of the data array.

2. The method of claim 1, wherein determining whether the entries comprise an entry that corresponds to the object in the data array comprises checking, by the controller, the tag entries and the floating tag entries in parallel.

3. The method of claim 1, wherein fetching or updating the object comprises:
determining, by the controller, whether the entry corresponding to the object is in the tag array or the floating tag array;
in case that the entry is in the tag array, fetching or updating, by the controller, the object in a first data entry of the data array, wherein the first data entry is implicitly associated with the entry in the tag array; and
in case that the entry is in the floating tag array, fetching or updating, by the controller, the object in a second data entry of the data array, wherein the second data entry is indicated by a location pointer of the entry in the floating tag array.

4. The method of claim 1, in case that the entries are without the entry that corresponds to the object, further comprising:
determining, by the controller, whether the data array comprises space to insert the object; and
in case that the data array comprises space to insert the object, inserting the object in a first data entry of the data array having space to insert the object and updating a tag entry of the tag array or a floating tag entry of the floating tag array, by the controller.

5. The method of claim 4, wherein inserting the object and updating the tag entry or the floating tag entry comprises:
determining, by the controller, whether the tag entry associated with the first data entry is unused;
in case that the tag entry is unused, inserting the object into the first data entry and updating the tag entry, by the controller; and
in case that the tag entry is used, inserting the object into the first data entry and updating the floating tag entry with a location pointer to the first data entry, by the controller.

6. The method of claim 5, in case that the data array is without space to insert the object, further comprising:
determining, by the controller, a second data entry of the data array for object replacement;
evicting one or more objects from the second data entry and clearing one or more of a corresponding tag entry of the tag array and a corresponding floating tag entry of the floating tag array, by the controller; and
inserting, by the controller, the object into the second data entry of the data array.

7. The method of claim 6, wherein evicting the one or more objects comprises:
determining, by the controller, whether the second data entry comprises one object or multiple objects;
in case that the second data entry comprises one object, evicting the one object and clearing the corresponding tag entry or the corresponding floating tag entry, by the controller; and
in case that the second data entry comprises multiple objects, evicting the multiple objects and clearing the corresponding tag entry and the corresponding floating tag entry, by the controller.

8. The method of claim 5, in case that the data array is without space to insert the object, further comprising:
determining, by the controller, at least one object for replacement with the object;
evicting the at least one object from a second data entry of the data array and clearing a corresponding tag entry of the tag array or a corresponding floating tag entry of the floating tag array, by the controller; and
inserting the object in the second data entry and updating the corresponding tag entry or the corresponding floating tag entry, by the controller.

9. A storage device comprising:
a cache memory comprising:
a data array comprising data entries;
a tag array comprising tag entries corresponding to the data entries of the data array; and
a floating tag array comprising floating tag entries associated with objects in one or more data entries of the data array, wherein the objects are smaller than or equal to a data entry size of the data array.

10. The storage device of claim 9, wherein the tag entries comprise a tag and a size bit indicating a size of an in a corresponding data entry of the data array.

11. The storage device of claim 9, wherein the floating tag entries comprise a tag and a location pointer indicating a data entry of the data array.

12. The storage device of claim 11, wherein the floating tag entries further comprise metadata indicating an offset of a corresponding object within a data entry of the data array.

13. A user equipment (UE) comprising:
a processor; and
a non-transitory computer readable storage medium storing instructions that, when executed, cause the processor to:
determine whether entries of a tag array and a floating tag array, in a cache memory of a storage device, comprise an entry that corresponds to an object, in a data array of the cache memory, that is to be fetched or updated; and
in case that that the entries comprise the entry that corresponds to the object, fetch or update the object in the data array by the controller,
wherein the entries comprise tag entries of the tag array and floating tag entries of the floating tag array, and
wherein the floating tag entries are associated with objects in one or more data entries of the data array, and the objects are smaller than or equal to a data entry size of the data array.

14. The UE of claim 13, wherein, in determining whether the entries comprise an entry that corresponds to the object in the data array, the instructions further cause the processor to check the tag entries and the floating tag entries in parallel.

15. The UE of claim 13, wherein, in fetching or updating the object, the instructions further cause the processor to:
determine whether the entry corresponding to the object is in the tag array or the floating tag array;
in case that the entry is in the tag array, fetch or update the object in a first data entry of the data array, wherein the first data entry is implicitly associated with the entry in the tag array; and
in case that the entry is in the floating tag array, fetch or update the object in a second data entry of the data array, wherein the second data entry is indicated by a location pointer of the entry in the floating tag array.

16. The UE of claim 13, in case that the entries are without the entry that corresponds to the object, the instructions further cause the processor to:
determine whether the data array comprises space to insert the object; and
in case that the data array comprises space to insert the object, insert the object in a first data entry of the data array having space to insert the object and update a tag entry of the tag array or a floating tag entry of the floating tag array.

17. The UE of claim 16, wherein, in inserting the object and updating the tag entry or the floating tag entry, the instructions further cause the processor to:
determine whether the tag entry associated with the first data entry is unused;
in case that the tag entry is unused, insert the object into the first data entry and update the tag entry; and
in case that the tag entry is used, insert the object into the first data entry and update the floating tag entry with a location pointer to the first data entry.

18. The UE of claim 17, in case that the data array is without space to insert the object, the instructions further cause the processor to:
determine a second data entry of the data array for object replacement;
evict one or more objects from the second data entry and clear one or more of a corresponding tag entry of the tag array and a corresponding floating tag entry of the floating tag array; and
insert the object into the second data entry of the data array.

19. The UE of claim 18, wherein, in evicting the one or more objects, the instructions further cause the processor to:
determine whether the second data entry comprises one object or multiple objects;
in case that the second data entry comprises one object, evict the one object and clear the corresponding tag entry or the corresponding floating tag entry; and
in case that the second data entry comprises multiple objects, evict the multiple objects and clear the corresponding tag entry and the corresponding floating tag entry.

20. The UE of claim 17, in case that the data array is without space to insert the object, the instructions further cause the processor to:
determine at least one object for replacement with the object;
evict the at least one object from a second data entry of the data array and clear a corresponding tag entry of the tag array or a corresponding floating tag entry of the floating tag array; and
insert the object in the second data entry and update the corresponding tag entry or the corresponding floating tag entry.
